(19) United States
(12) Patent Application Publication
(10) Pub. No.: US 2008/0106430 A1
(43) Pub. Date: May 8, 2008

(54) Modular LED warning lamp

(76) Inventor: Peter Yeh, Tainan Hsien (TW)

Correspondence Address: Thomas E. Sisson;Jackson Walker, LLP, Suite 2400, 112 E. Pecan, San Antonio, TX, 78205, US

(21) Appl. No.: 11/591,739

(22) Filed: Nov. 2, 2006

(51) Int. Cl. G08B 5/36

(52) U.S. Cl. 340/815.73; 340/540

(57) ABSTRACT

A modular LED warning lamp has a base, a lamp module and a lamp shade. The lamp module is mounted on the base and has a positioning sleeve, multiple circuit panels and a circuit board. The positioning sleeve has multiple positioning sections formed and arranged circularly on an outer wall of the positioning sleeve. Each circuit panel is mounted individually on one of the positioning sections and has at least one LED. The circuit board is connected electrically to the LEDs. The circuit panels can be selectively mounted on some specific positioning sections to achieve a desired emitting angular range. Additionally, The circuit panels can be standardized to various types, which with different numbers of LEDs for use in the positioning sleeve. Such that, time and cost for developing a warning lamps with specific brightness and emitting angular range are reduced.

### BACKGROUND OF THE INVENTION

1. Field of the Invention

The present invention relates to an LED warning lamp and more particularly to a modular LED warning lamp which can be readily customized for various types and reduce development time and production costs.

2. Description of Related Art

Because LEDs (Light Emitting Diode) have an advantage of low electricity consuming, LEDs are used as lighting elements in most warning lamps to provide a durable warning and lighting effect.

Generally, a conventional LED warning lamp has a base, a lighting assembly and a lamp shade. The lighting assembly is mounted on the base and has a circuit board and multiple LEDs. The multiple LEDs are mounted on the circuit board and are connected electrically to a power source to provide a durable warning and lighting effect. The lamp shade is mounted on the base and covers the LEDs inside.

LED warning lamps used in different environment are designed to have different brightness and emitting angular ranges to provide multiple suitable warning and lighting effects for different environments. However, all the LEDs are mounted on a single circuit board, result in a difficulty for the LED warning lamp reaching a modular design. Once a number of the LEDs is increased to increase the brightness of the LED warning lamp, specification and dimension of the circuit board must be redesigned to fit with the LEDs. Additional, specifications and dimensions of the base and the lamp shade also have to be redesigned to fit with the changed circuit board. Likewise, to widen the emitting angular range of the LED warning lamp, the specifications of the circuit board, the base and the lamp base all have to be redesigned, which prolongs the development time and increases production costs.

### SUMMARY OF THE INVENTION

The primary objective of the present invention is to provide a modular LED warning lamp which can be readily customized for various types and reduce development time and production costs for the warning lamp.

The modular LED warning lamp comprises a base, a lamp module and a lamp shade. The lamp module is mounted on the base and has a positioning sleeve, multiple circuit panels and a circuit board. The positioning sleeve has a top end, an outer wall and multiple positioning sections. The multiple positioning sections are elongated and are formed and arranged circularly on the outer wall of the positioning sleeve to face different directions.

Each of the circuit panels is mounted individually on one of the positioning sections on the outer wall of the positioning sleeve and has a circuit mounted on the circuit panel and at least one LED mounted on the circuit panel and connected electrically to the circuit. Accordingly, the LEDs on the circuit panels mounted on the positioning sections are capable of emitting lights toward the directions that the positioning sections face to achieve a wide-ranging lightening effect. Additionally, a number of the circuit panels may be less than that of the positioning sections, such that the circuit panels can be selectively mounted on some specific positioning sections to achieve a desired emitting angular range. Further, the circuit panels may be standardized with various types, which have different numbers of LEDs to build a design database. All the circuit panels in the database are compatible with the positioning sleeve. Therefore, to develop a warning lamp with a specific brightness can be readily performed by appropriately selecting circuit panels with desired numbers of LEDs from the design database.

The circuit board is mounted on the top end of the positioning sleeve and has a circuit mounted on the circuit board and connected electrically to the at least one LEDs of each of the circuit panels.

The lamp shade is transparent and is mounted on the base to cover the lamp module.

The module LED warning lamp makes a development of a warning lamp with a specific brightness and emitting angular range efficient and convenient. To redesign the circuit board, the base or the lamp shade is unnecessary, and this greatly reduces development time and production costs to the warning lamp and improves a competitiveness of the warning lamp.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a modular LED warning lamp in accordance with the present invention;

FIG. 2 is a front view in partial section of the modular LED warning lamp in FIG. 1;

FIG. 3 is a front view of the modular LED warning lamp in FIG. 1, with a lamp shade and a refractional sleeve of the modular LED warning lamp being detached off;

FIG. 4 is a front view of a second embodiment of the modular LED warning lamp in accordance with the present invention, with a lamp shade and a refractional sleeve of the modular LED warning lamp being detached off; and

FIG. 5 is a front view of a third embodiment of the modular LED warning lamp in accordance with the present invention, with a lamp shade and a refractional sleeve of the modular LED warning lamp being detached off.

FIG. 6 is a block diagram of the modular LED warning lamp in FIG. 1.

### DETAILED DESCRIPTION OF THE PREFERRED EMBODIMENT

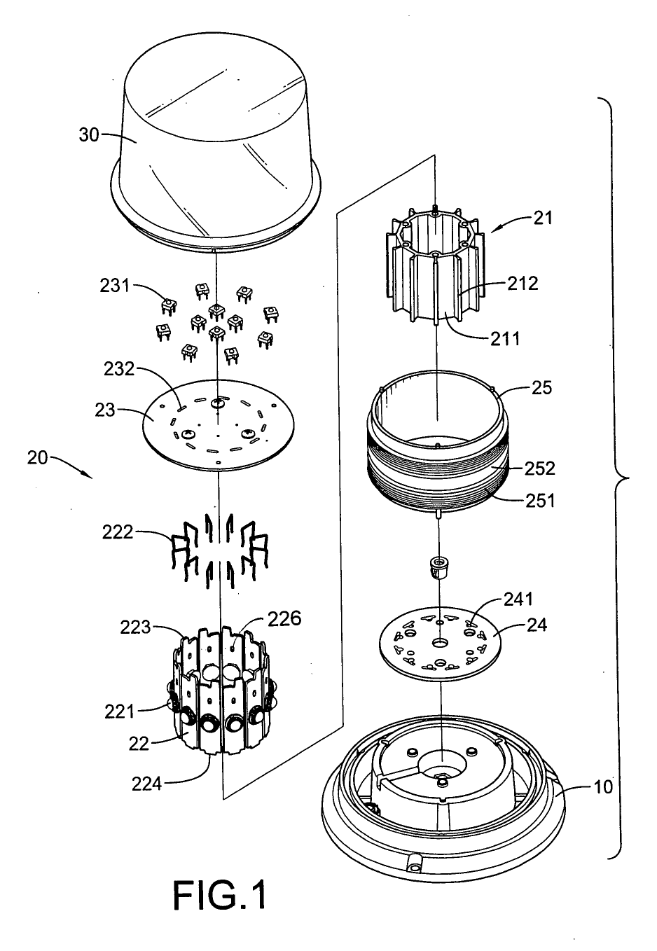

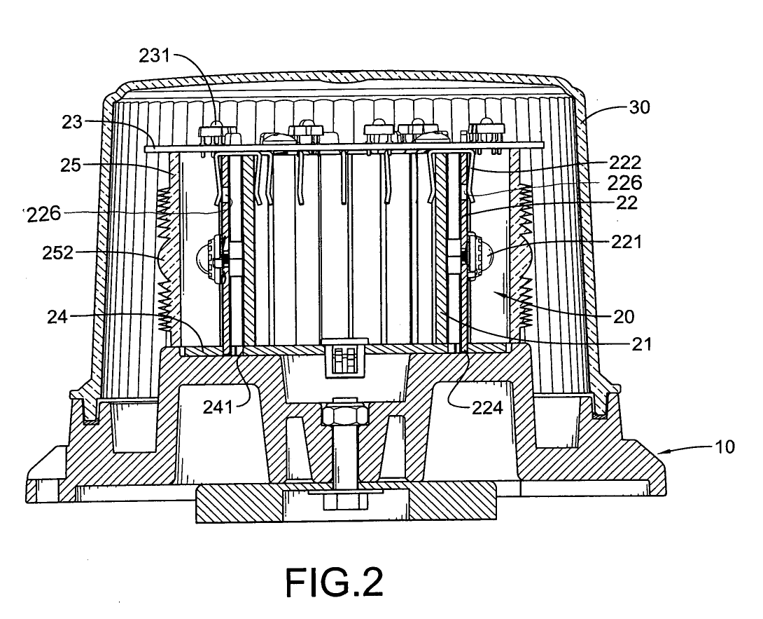

With reference to FIGS. 1-4, a modular LED warning lamp in accordance with the present invention comprises a base (10), a lamp module (20), a refractional sleeve (25) and a lamp shade (30).

The lamp module (20) is mounted on the base (10) and has a positioning sleeve (21), multiple circuit panels (22, 22′), a circuit board (23), a positioning bottom board (24) and may be implemented in several ways.

The positioning sleeve (21) has a top end, a bottom end, an outer wall, multiple positioning sections (211) and multiple partitions (212) and may be circular or polygonal, e.g. orthogonal, hexagonal, octagonal or the like. The positioning sections (211) are formed and arranged circularly on the outer wall of the positioning sleeve (21) and each of the positioning sections (211) is elongated. Because the positioning sections (211) are arranged circularly on the outer wall of the positioning sleeve (21), the positioning sections (211) face different directions. The partitions (212) are formed on and protrude from the outer wall of the positioning sleeve (21) and locate respectively between each pair of adjacent positioning sections (211).

Each circuit panel (22, 22′) is mounted individually on one of the positioning sections (211) on the outer wall of the positioning sleeve (21), is retained by two adjacent partitions (212), has a top end, a bottom end, a circuit (225), at least one LED (221), a clip (222), a top connecting protrusion (223), a bottom connecting protrusion (224) and may be implemented in several ways.

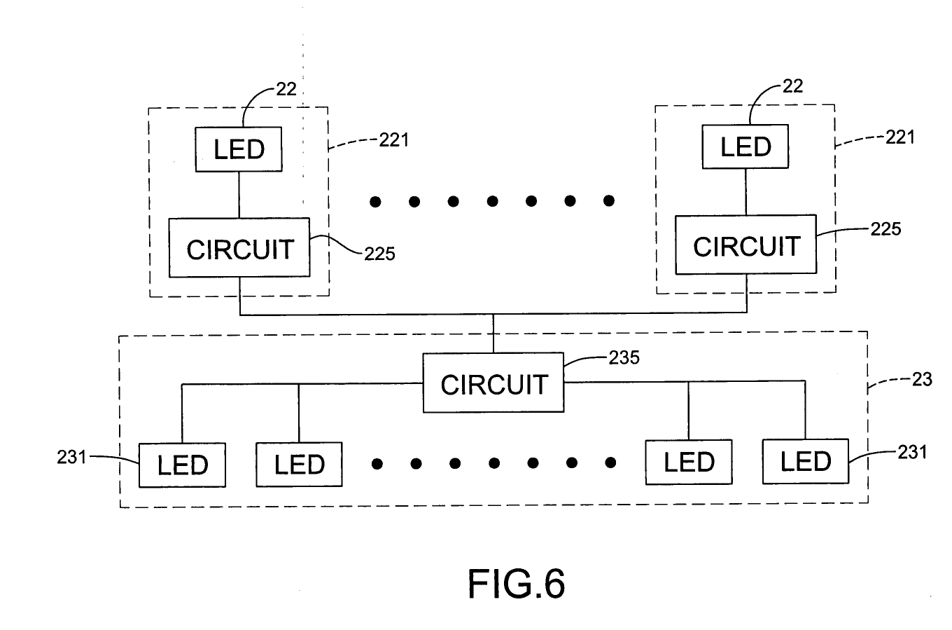

With further reference to FIG. 6, the circuit (225) is mounted on the circuit panel (22, 22′). The at least one LED (221) is mounted on the circuit panel (22, 22′) and is connected electrically to the circuit (225) on the circuit panel (22, 22′).

The clip (222) is mounted on the top end of the positioning sleeve (21) and has two legs respectively pressing the position sleeve (21) and the circuit panel (22, 22′) to clip and hold the circuit panel (22, 22′) on the positioning sleeve (21).

The top connecting protrusion (223) is formed on and protrudes from the top end of the circuit panel (22). The bottom connecting protrusion (224) is formed on and protrudes from the bottom of the circuit panel (22).

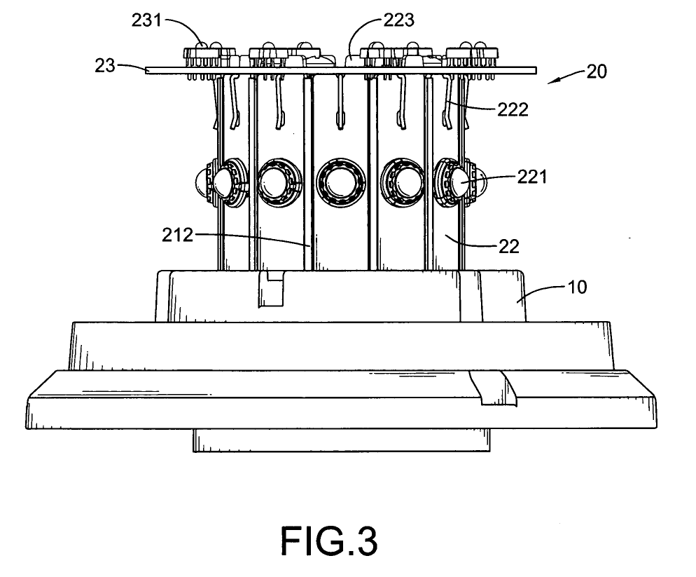

With further reference to FIG. 3, in a first embodiment of the circuit panel (22), the circuit panel (22) has a single LED (221).

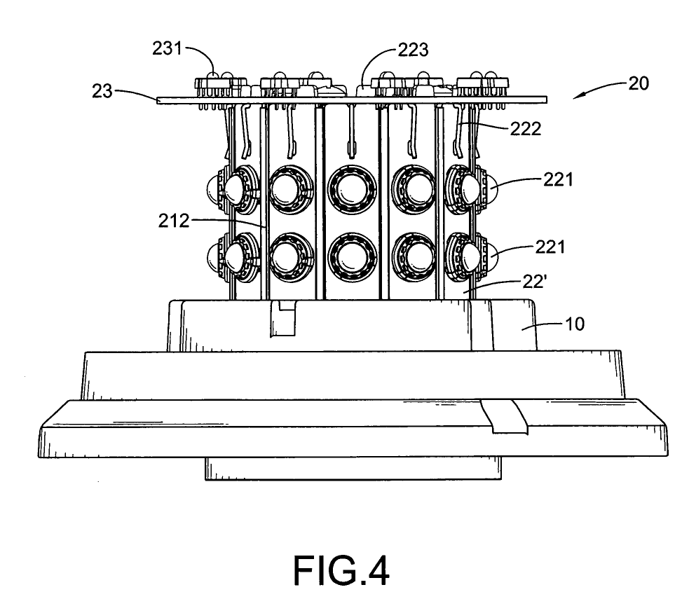

With further reference to FIG. 4, in a second embodiment of the circuit panel (22′), the circuit panel (22′) has multiple LEDs (221).

Brightness of the warning lamp depends on how many LEDs (221) the warning lamp has. After the circuit panels (22, 22′) with different numbers of LEDs (221) are standardized to establish a design database, to develop a warning lamp with a specific brightness can be readily performed by appropriately selecting circuit panels (22, 22′) with desired numbers of LEDs from the design database.

The circuit board (23) is mounted on the top end of the positioning sleeve (21), is connected electrically to the at least one LED (221) of each of the circuit panels (22), has a top, a circuit (235), multiple LEDs (231) and multiple top connecting recesses (232) and may be implemented in several ways.

With further reference to FIG. 6, the circuit (235) is mounted on the circuit board (23) and is connected electrically to the at least one LED (221) of each of the circuit panels (22). The LEDs (231) are mounted on the top of the circuit board (23) and are connected electrically to the circuit (235) on the circuit board (23) to emit light upward. The top connecting recesses (232) are formed in the circuit board (23) and respectively align with and hold the top connecting protrusions (223) of the circuit panels (22) to attach the circuit panels (22) securely on the circuit board (23).

In a first embodiment of the circuit board (23), the circuit board (23) is connected electrically to the at least one LED (221) of each of the circuit panels (22) by multiple leading wires. The leading wires connect the LEDs (221) with the circuit board (23) to achieve electrical connection between the LEDs (221) and the circuit board (23).

In a second embodiment of the circuit board (23), the circuit board (23) is connected electrically to the at least one LED (221) of each of the circuit panels (22) by connecting the circuit on the circuit board (23) directly with the circuit on each circuit panel (22). When the top connecting recesses (232) hold the top connecting protrusions (223), the circuit on each circuit panel (22) directly contacts with the circuit on the circuit board (23) to achieve the electrical connection between the LEDs (221) and the circuit board (23). Further, the top connecting protrusions (223) may be respectively held securely in the top connecting recesses (232) by welding to ensure the electrical connection between the LEDs (221) and circuit board (23).

The positioning bottom board (24) is mounted on the bottom end of the positioning sleeve (21) and has multiple bottom connecting recesses (241). The bottom connecting recesses (241) are formed in the positioning bottom board (24) and respectively align with and hold the bottom connecting protrusions (224) of the circuit panels (22) to attach the circuit panels (22) securely on the positioning bottom board (24).

With reference to FIGS. 1 and 3, in a first embodiment of the lamp module (20), a number of the circuit panel (22, 22′) equals to that of the positioning sections (211). Thus, the circuit panels (22, 22′) are mounted respectively on all of the positioning sections (211) and achieve a 360-degree emitting range.

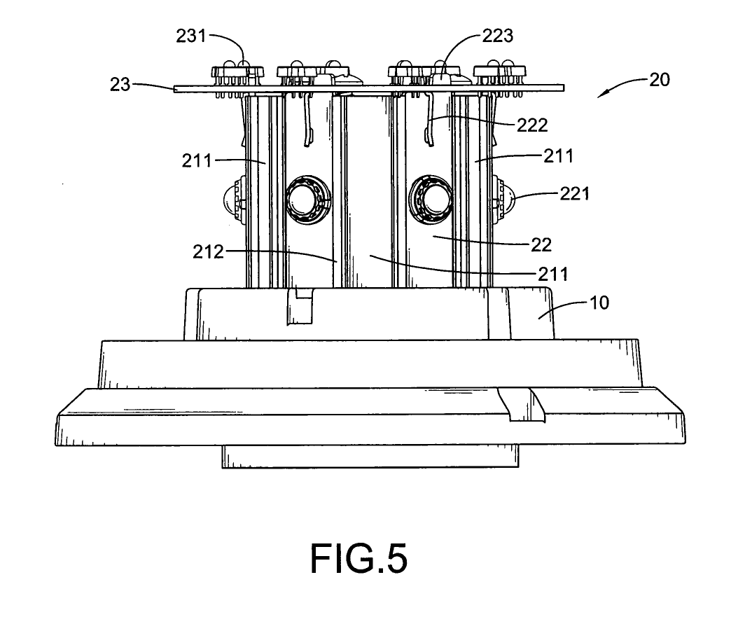

With reference to FIG. 5, in a second embodiment of the lamp module (20), a number of the circuit panel (22) is less than that of the positioning sections (211). Thus, the circuit panels (22, 22′) can be selectively mounted on some of the positioning sections (211) to achieve a desired emitting angular range.

The refractional sleeve (25) is mounted on the base (10), encircles the positioning sleeve (21) and has a circumferential wall and a refractional pattern region. The refractional pattern region is formed on the circumferential wall of the refractional sleeve (25) to refract lights emitting from the LEDs (221) to display a special light source and achieve an enhanced warning effect. The refractional pattern region may be multiple annular grooves (251), an annular protrusion (252) or the like.

The lamp shade (30) is transparent and is mounted on the base (10) to cover the lamp module (20) to protect the lamp module (20) from water or dusts.

To standardize the positioning sleeve (21) to build a design database of various positioning sleeves (21) having different maximum numbers of the positioning sections (211) based on the design database of the circuit panels (22) will make a development of a warning lamp with a specific brightness and emitting angular range fast, efficient and convenient. To redesign the circuit board (23), the base (10), the lamp shade (30) or other components of the warning lamp is unnecessary, and this will greatly reduce development time and production costs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A modular LED warning lamp comprising:
a base;
a lamp module mounted on the base and having
a positioning sleeve having
a top end;
a bottom, end;
an outer wall; and
multiple positioning sections formed and arranged circularly on the outer wall of the positioning sleeve and each of the positioning sections being elongated;
multiple circuit panels each being mounted individually on one of the positioning sections on the outer wall of the positioning sleeve and having
a top end;
a bottom end;
a circuit mounted on the circuit panel; and
at least one LED mounted on the circuit panel and connected electrically to the circuit on the circuit panel; and
a circuit board mounted on the top end of the positioning sleeve, connected electrically to the at least one LED of each of the circuit panels and having
a top; and
a circuit mounted on the circuit board and connected electrically to the at least one LED of each of the circuit panels; and
a lamp shade being transparent and mounted on the base to cover the lamp module, wherein
each of the circuit panels further has a clip mounted across the top ends of the positioning sleeve and the circuit panel and having two legs respectively pressing the top ends of the position sleeve and the circuit panel to clip and hold the circuit panel on the positioning sleeve;
each circuit panel has a hole defined near the top end; and
one leg of the clip of each circuit panel engages with, the hole in the circuit panel.

2. The modular LED warning lamp as claimed in claim 1, wherein
the positioning sleeve further has multiple partitions formed on and protruding from the outer wall of the positioning sleeve and locating respectively between each pair of adjacent positioning sections; and
each of the circuit panels is retained by adjacent partitions.

3. The modular LED warning lamp as claimed in claim 1, wherein the circuit board further has multiple LEDs mounted on the top of the circuit board and are connected electrically to the circuit on the circuit board.

4. (canceled)

5. The modular LED warning lamp as claimed in claim 1, wherein
each of the circuit panels further has
a top connecting protrusion formed on and protruding from the top end of the circuit panel; and
a bottom connecting protrusion formed on and protruding from the bottom of the circuit panel;
the circuit board further has multiple top connecting recesses formed in the circuit board and respectively aligning with and holding the top connecting protrusions of the circuit panels; and
the lamp module further has a positioning bottom board mounted on the bottom end of the positioning sleeve and having multiple bottom connecting recesses formed in the positioning bottom board and respectively aligning with and holding the bottom connecting protrusions of the circuit panels.

6. The modular LED warning lamp as claimed in claim 1 further has a refractional sleeve mounted on the base, encircling the positioning sleeve and having
a circumferential wall; and
a refractional pattern region formed on the circumferential wall of the refractional sleeve.

7. The modular LED warning lamp as claimed in claim 1, wherein each of the circuit panels has a single LED.

8. The modular LED warning lamp as claimed in claim 1, wherein each of the circuit panels has multiple LEDs.

9. The modular LED warning lamp as claimed in claim 1, wherein a number of the circuit panels equals to that of the positioning sections and the circuit panels are mounted respectively on all of the positioning sections.
